(19) United States
(12) Patent Application Publication
(10) Pub. No.: US 2026/0082066 A1
(43) Pub. Date: Mar. 19, 2026

(54) VIDEO DECODING WITH LOSSY REFERENCE FRAME

(71) Applicant: QUALCOMM Incorporated, San Diego, CA (US)

(72) Inventors: Shengqi Yang, Carlsbad, CA (US); Changhyun Lee, San Diego, CA (US); Sai Kashyap Gobburi, Nalgonda (IN)

(21) Appl. No.: 18/890,005

(22) Filed: Sep. 19, 2024

(51) Int. Cl. H04N 19/44; H04N 19/105; H04N 19/172

(52) U.S. Cl. CPC H04N 19/44; H04N 19/105; H04N 19/172

(57) ABSTRACT

A device for decoding video data includes an integrated circuit (IC) comprising a video decoder, and a memory that is external to the IC and coupled to the IC. The video decoder is configured to in a first mode, decode a first frame based on a first reference frame stored in the memory, and in a second mode, decode a second frame based on a second lossy reference frame, wherein the second lossy reference frame is generated based on decompression of a lossy compressed reference frame.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for operating a video decoder in a first mode or a second mode. In the first mode, also called normal mode, to decode a frame, the video decoder may utilize reference frames that are effectively the same as the reference frames used by the video encoder to encode the frame. In the second mode, also called low power mode, to decode a frame, the video decoder may utilize lossy reference frames, where the lossy reference frames differ than the reference frames used by the video encoder to encode the frame. For instance, the lossy reference frames may be the actual reference frames that have been compressed using lossy compression, and then decompressed. A user may not experience much impact on visual quality in the second mode, but there may be power savings that improve device longevity before recharge, which may improve user experience. Accordingly, the example techniques described in this disclosure may improve device operation, such as by increasing device longevity before recharge without impact on user experience.

In one example, the disclosure describes a device for decoding video data, the device comprising: an integrated circuit (IC) comprising a video decoder; and a memory that is external to the IC and coupled to the IC, wherein the video decoder is configured to: in a first mode, decode a first frame based on a first reference frame stored in the memory; and in a second mode, decode a second frame based on a second lossy reference frame, wherein the second lossy reference frame is generated based on decompression of a lossy compressed reference frame.

In one example, the disclosure describes a method of decoding video data, the method comprising: in a first mode, decoding, with a video decoder in an integrated circuit (IC), a first frame based on a first reference frame stored in memory that is external to the IC and coupled to the IC; and in a second mode, decoding, with the video decoder, a second frame based on a second lossy reference frame, wherein the second lossy reference frame is generated based on decompression of a lossy compressed reference frame.

In one example, the disclosure describes one or more computer-readable storage media storing instructions thereon that when executed cause a video decoder in an integrated circuit (IC) to: in a first mode, decode a first frame based on a first reference frame stored in memory that is external to the IC and coupled to the IC; and in a second mode, decode a second frame based on a second lossy reference frame, wherein the second lossy reference frame is generated based on decompression of a lossy compressed reference frame.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram illustrating an example a computing device that may perform the techniques of this disclosure.

FIGS. 3A and 3B are flow diagrams illustrating examples of frames that are compressed using lossless or lossy compression.

FIG. 4 is a flowchart illustrating an example method of processing video data.

FIG. 5 is a flowchart illustrating another example method of processing video data.

FIG. 6 is a flowchart illustrating another example method of processing video data.

### DETAILED DESCRIPTION

Inter-prediction is an example video encoding or decoding technique for encoding or decoding a current block in a current picture. In inter-prediction, a video encoder or video decoder determine a reference block in a reference picture. The video encoder or video decoder may generate a prediction block from the reference block (e.g., by filtering, etc.). In some examples, the prediction block and reference block are the same blocks. The video encoder determines residual information indicative of a difference between samples of the prediction block and the current block, and signals the residual information. The video decoder receives the residual information, and adds the residual information to the prediction block to reconstruct the current block.

The video decoder writes the current picture to memory. The current picture can then be a reference picture for decoding one or more future pictures. Future pictures refer to pictures that follow the current picture in coding order (i.e., are decoded after the current picture). That is, one or more future pictures may use the current picture for inter-prediction.

For the video decoder, there may be different types of memory that are available for writing the current picture. For instance, an integrated circuit (IC) chip that includes the video decoder may have dedicated chip memory, which may be on-chip or off-chip and accessible by a dedicated bus. The dedicated chip memory may be shared by components of the IC chip, but may not be accessible by other chips. One example of the dedicated chip memory is system cache memory.

Also, the device that includes the IC chip may include system memory that is external to the IC, and not dedicated to the IC chip. For instance, the IC chip may be part of a larger device (e.g., phone, tablet, laptop, etc.), and the system memory is shared by the components of the device. Random access memory (RAM) is an example of non-dedicated system memory, such as double data rate synchronous dynamic random-access memory (DDR SDRAM).

The factors that impact power consumption include the amount of data that is written to or read from the system memory, and the amount of memory space that is allocated for storage in the system memory. In general, power consumption is lower if less data is written to or read from the system memory, as compared to if more data is written to or read from the system memory. Similarly, power consumption is lower if less storage space is allocated, as compared to more storage space is allocated.

To reduce the amount of data that is written to or read from the system memory, the IC may include compression circuitry to compress a frame prior to writing to the system memory. The compression circuitry may be configured to perform a relatively fast compression scheme based on the content of the frame being written to memory, and possibly no other frame.

In accordance with one or more examples, the system may operate in a first mode or a second mode. In the first mode, the compression circuitry may be configured to perform lossless compression on a frame to generate a lossless compressed frame, and write the lossless compressed frame to the system memory. Decompression circuitry may read the lossless compressed frame, and perform decompression to reconstruct the frame as a reference frame. The video decoder may use the reference frame to decode a subsequent frame. In some examples, in the first mode, lossless compression and decompression may not be needed.

In a second mode, the compression circuitry may be configured to perform lossy compression on a frame to generate a lossy compressed frame, and write the lossy compressed frame to the system memory. In some examples, the compression circuitry may be configured to perform lossy compression in a manner that guarantees an amount of compression. For instance, the lossy compression may guarantee a 2:1 compression ratio, which means that the amount of compressed data is guaranteed to be less than or equal to half of the amount of the original data. Such guaranteed compression may allow for reduced allocation of storage in the system memory. Decompression circuitry may read the lossy compressed frame, and perform decompression to reconstruct the frame as a lossy reference frame. The video decoder may use the lossy reference frame to decode a subsequent frame.

The amount of data to be written and read for the lossy compressed frame tends to be less than the amount of data to be written and read for the lossless compressed frame or where no compression is applied. Therefore, in the second mode, there may be power savings by performing lossy compression on a frame prior to writing, and also, there may be power saving when reading since there is less data to read. In some cases, the power savings may be more significant when reading since the write operation of a frame to system memory occurs once, but the read operation of that frame may occur multiple times if that frame is a reference frame for multiple subsequent frames.

However, there may be some impact on visual quality in the second mode. For example, as described above, the video encoder may signal residual values indicative of difference between a frame that is being decoded and the reference frame, and the video decoder may add the residual values to the reference frame to reconstruct the frame. In the second mode, the video decoder may add the residual values to the lossy reference frame, and the lossy reference frame may be slightly different than the actual reference frame. Therefore, the reconstructed frame may have reduced visual quality as compared to the visual quality of the frame at the time of encoding because the video decoder added the residual values to the lossy reference frame instead of the actual reference frame to reconstruct the frame.

The impact on visual quality described above when lossy compression is used may not be present when lossless compression is used. As the compression is lossless, after decompression of the lossless compressed frame, the resulting reference frame may be identical to the reference frame that the video encoder used for encoding.

In most cases, the impact on the visual quality to the reconstructed frame may be relatively minimal, and imperceivable to the user. Accordingly, it may be possible to operate in the second mode whenever a device that includes the IC chip is not connected to power. This disclosure describes additional techniques that may reduce the negative impact on visual quality, while still achieving some level of power reduction.

As one example, the video decoder may be configured to operate in the first mode or the second mode based one or more of a resolution of frames to be decoded, a power level of the device, or a user selection. For instance, if a resolution of a frame is 1920×1080, the compression circuitry may lossy compress this frame for storage, and the video decoder may use the lossy reference frame for decoding. For other resolutions, the compression circuitry may lossless compress or not compress the frame for storage. If a power level of the device is less than a certain power level (e.g., less than 30% charge on the battery), the video decoder and the compression circuitry may transition to the second mode. In some cases, the user may proactively select the second mode, such as if the power level is low or the user anticipates that the battery will run out of charge before the user completes watching. The compression circuitry and the video decoder may otherwise operate in the first mode.

In some examples, to reduce visual impact, in the second mode, the compression circuitry may perform lossy compression on chroma component of frames. However, for the luma component of the same frame, the compression circuitry may perform lossless compression. In this case, the lossy reference frame may be a lossy chroma with lossless luma reference frame. Decoding the chroma component of a frame using a lossy chroma reference frame may have reduced negative impact on visual quality as compared to using a lossy luma component reference for decoding the reference frame. Accordingly, in the second mode, the video decoder may decode the chroma component of the frame using a lossy chroma component of the reference frame, but decode the luma component of the frame using a lossless luma component of the reference frame. Lossy compression of the chroma component, but not the luma component is one example, and the techniques should not be considered limited. The lossy reference frame when the lossy compression is applied to the chroma component and not the luma component is referred to as a chroma lossy and luma lossless reference frame.

In this disclosure, the term “frame” may be used to describe the combination of the chroma and luma components. However, at times, the term “frame” may be used to refer to a color component. For example, a first frame and a second frame may each be frames that include luma and chroma components. In some examples, the first frame may refer to a luma component of the frame, and the second frame may refer to a chroma component of the frame.

As another example, to reduce the impact on visual quality, the compression circuitry and the video decoder may toggle between the first mode and the second mode to minimize the accumulation of visual quality degradation. For instance, as described above, if a frame is decoded using a lossy reference frame, the reconstructed frame is slightly different than the frame that the video encoder encoded. This reconstructed frame may be a first reconstructed frame. In the second mode, the compression circuitry may then lossy compress the first reconstructed frame, and write the lossy first reconstructed frame. Then, when for a subsequent frame, the video decoder may use the lossy first reconstructed frame (e.g., after decompression) as a reference to reconstruct the subsequent frame. In this case, because the subsequent frame is reconstructed from a lossy first reconstructed frame, where the first reconstructed frame was reconstructed from a lossy reference frame, the slight variations in each of the lossy frames compounds, resulting in increasing amounts of visual quality degradation.

In one or more examples, a sequence of frames, also called a group of pictures, leads with an intra refresh frame. An intra refresh frame may be a frame that does not need another frame for decoding purposes. In some examples, frames prior to the intra refresh frame may not be used as reference frames for frames following the intra refresh frame. Accordingly, in some examples, if a frame is an intra refresh frame, the compression circuitry may perform lossless compression (e.g., operate in the first mode). This way, the compounding of the visual quality degradation is halted.

As another example, after lossy compressing, the compression circuitry may be configured to determine a compression value that is indicative of an amount by which the frame is compressed. As one example, the compression value may be a ratio of amount of data in the uncompressed frame to the amount of data in the compressed frame (e.g., 2:1 would mean the compressed frame has half the amount of data as the uncompressed frame).

In some cases, if the compression circuitry is able to highly compress multiple consecutive frames, there is a higher probability that visual quality is degrading faster than desired. If the compression circuitry determines that the compression amount satisfies a threshold (e.g., is greater than or less than a threshold based on how compression amount is defined) for a set number of frames (e.g., measured as actual number of consecutive frames or as an amount of time it would take for the frames to be displayed), the compression circuitry may toggle from the second mode to the first mode, where lossless compression is applied.

Stated another way, the compression circuitry may perform lossy compression on a first set of frames to generate a first set of lossy frames, and determine a compression value for each lossy frame of the first set of lossy frames. The compression value may be indicative of an amount by which each frame in the first set of lossy frames is compressed. The compression circuitry may determine that the compression value for each lossy frame of the first set of lossy frames satisfies a threshold, and based on the determination that the compression value for each lossy frame of the first set of lossy frame satisfies the threshold, perform lossless compression for a second set of frames following the first set of frames to generate a set of lossless frames (e.g., operate in the first mode). The video decoder may then decode a subsequent frame based on the set of lossless frames (e.g., operate in the first mode).

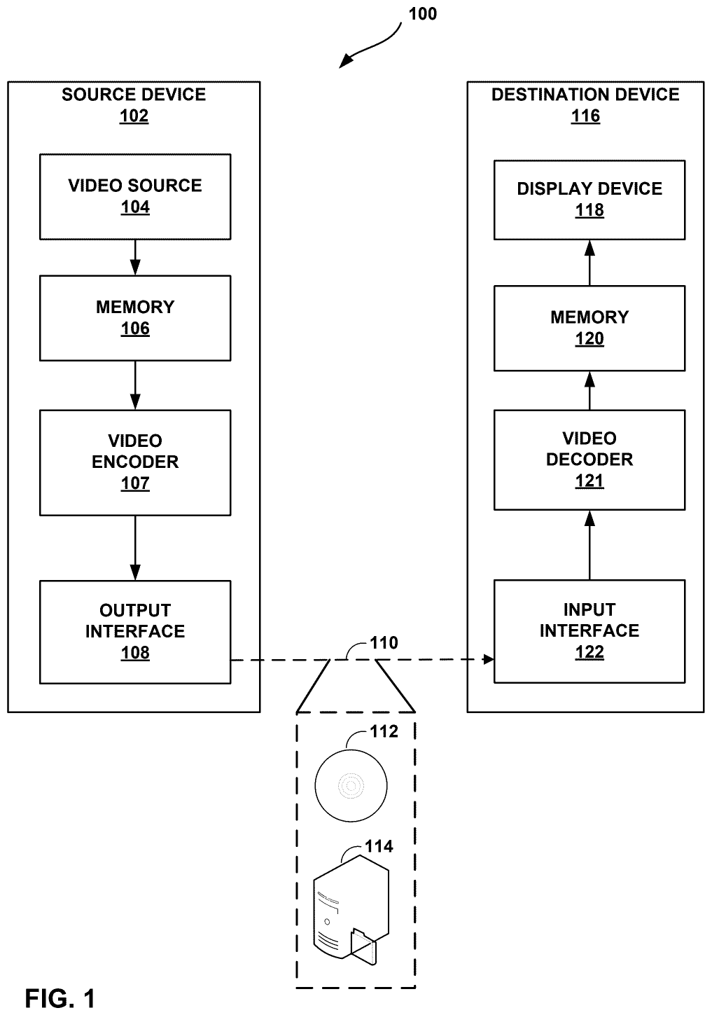

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 107, and output interface 108. Destination device 116 includes input interface 122, video decoder 121, memory 120, and display device 118. In accordance with this disclosure, video decoder 121 of destination device 116 may be configured to apply the techniques for operating in a first mode (e.g., normal mode) or a second mode (e.g., low power mode), where in the second mode, a frame is written to memory using lossy compression techniques and that lossy compressed frame is used as a lossy reference frame for decoding a subsequent frame. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 107 and video decoder 121 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 107, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 107 encodes the captured, pre-captured, or computer-generated video data. Video encoder 107 may rearrange the pictures from the received order (sometimes referred to as “display order”) into a coding order for coding. Video encoder 107 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 121. Additionally or alternatively, memories 106, 120 may store software instructions executable by, e.g., video encoder 107 and video decoder 121, respectively. Although memory 106 and memory 120 are shown separately from video encoder 107 and video decoder 121 in this example, it should be understood that video encoder 107 and video decoder 121 may also include internal memories for functionally similar or equivalent purposes. Furthermore, memories 106, 120 may store encoded video data, e.g., output from video encoder 107 and input to video decoder 121. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like.

In some examples, source device 102 and/or destination device 116 may include respective system-on-a-chip (SoC) devices. For example, source device 102 may include an SoC device to perform the functionality attributed to video encoder 107 and/or output interface 108, and destination device 116 may include an SoC device to perform the functionality attributed to video decoder 121 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 107, which is also used by video decoder 121, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 107 and video decoder 121 may each be integrated with an audio encoder and/or audio decoder (e.g., audio codec), and may include appropriate MUX-DEMUX units, or other hardware and/or software, to handle multiplexed streams including both audio and video in a common data stream. Example audio codecs may include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, iLBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Aud.

Video encoder 107 and video decoder 121 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 107 and video decoder 121 may be included in one or more encoders or decoders, either of which may be integrated as part of a combined encoder/decoder (CODEC) in a respective device. A device including video encoder 107 and/or video decoder 121 may implement video encoder 107 and/or video decoder 121 in processing circuitry such as an integrated circuit and/or a microprocessor. Such a device may be a wireless communication device, such as a cellular telephone, or any other type of device described herein.

Video encoder 107 and video decoder 121 may operate according to a video coding standard, such as ITU-T H.265, also referred to as High Efficiency Video Coding (HEVC) or extensions thereto, such as the multi-view and/or scalable video coding extensions. Alternatively, video encoder 107 and video decoder 121 may operate according to other proprietary or industry standards, such as ITU-T H.266, also referred to as Versatile Video Coding (VVC). In other examples, video encoder 107 and video decoder 121 may operate according to a proprietary video codec/format, such as AOMedia Video 1 (AV1), extensions of AV1, and/or successor versions of AV1 (e.g., AV2). In other examples, video encoder 107 and video decoder 121 may operate according to other proprietary formats or industry standards. The techniques of this disclosure, however, are not limited to any particular coding standard or format. In general, video encoder 107 and video decoder 121 may be configured to perform the techniques of this disclosure in conjunction with any video coding techniques that uses inter-prediction coding.

In general, video encoder 107 and video decoder 121 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 107 and video decoder 121 may code video data represented in a YUV (e.g., Y, Cb, Cr) format. That is, rather than coding red, green, and blue (RGB) data for samples of a picture, video encoder 107 and video decoder 121 may code luminance (luma) and chrominance (chroma) components, where the chrominance components may include both red hue and blue hue chrominance components. In some examples, video encoder 107 converts received RGB formatted data to a YUV representation prior to encoding, and video decoder 121 converts the YUV representation to the RGB format. Alternatively, pre-and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 107) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 107 and video decoder 121 may be configured to operate according to VVC. According to VVC, a video coder (such as video encoder 107) partitions a picture into a plurality of CTUs. Video encoder 107 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 107 and video decoder 121 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 107 may further partition a superblock into smaller coding blocks. Video encoder 107 may partition a superblock and other coding blocks into smaller blocks using square or non-square partitioning. Non-square blocks may include N/2×N, N×N/2, N/4×N, and N×N/4 blocks. Video encoder 107 and video decoder 121 may perform separate prediction and transform processes on each of the coding blocks.

AV1 also defines a tile of video data. A tile is a rectangular array of superblocks that may be coded independently of other tiles. That is, video encoder 107 and video decoder 121 may encode and decode, respectively, coding blocks within a tile without using video data from other tiles. However, video encoder 107 and video decoder 121 may perform filtering across tile boundaries. Tiles may be uniform or non-uniform in size. Tile-based coding may enable parallel processing and/or multi-threading for encoder and decoder implementations.

In some examples, video encoder 107 and video decoder 121 may use a single QTBT or MTT structure to represent each of the luminance and chrominance components, while in other examples, video encoder 107 and video decoder 121 may use two or more QTBT or MTT structures, such as one QTBT/MTT structure for the luminance component and another QTBT/MTT structure for both chrominance components (or two QTBT/MTT structures for respective chrominance components). Video encoder 107 and video decoder 121 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 107 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 107 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 107 may generate the prediction block using one or more motion vectors. Video encoder 107 may generally perform a motion search to identify a reference block that closely matches the CU, e.g., in terms of differences between the CU and the reference block. Video encoder 107 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 107 may predict the current CU using uni-directional prediction or bi-directional prediction.

Video encoder 107 encodes data representing the prediction mode for a current block. For example, for inter-prediction modes, video encoder 107 may encode data representing which of the various available inter-prediction modes is used, as well as motion information for the corresponding mode. For uni-directional or bi-directional inter-prediction, for example, video encoder 107 may encode motion vectors using advanced motion vector prediction (AMVP) or merge mode. Video encoder 107 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 107 and video decoder 121 do not use video data from other frames of video data. For most intra prediction modes, video encoder 107 encodes blocks of a current frame based on the difference between sample values in the current block and predicted values generated from reference samples in the same frame. Video encoder 107 determines predicted values generated from the reference samples based on the intra prediction mode.

Following prediction, such as intra-prediction or inter-prediction of a block, video encoder 107 may calculate residual data for the block. The residual data, such as a residual block, represents sample by sample differences between the block and a prediction block for the block, formed using the corresponding prediction mode. Video encoder 107 may apply one or more transforms to the residual block, to produce transformed data in a transform domain instead of the sample domain. For example, video encoder 107 may apply a discrete cosine transform (DCT), an integer transform, a wavelet transform, or a conceptually similar transform to residual video data. Additionally, video encoder 107 may apply a secondary transform following the first transform, such as a mode-dependent non-separable secondary transform (MDNSST), a signal dependent transform, a Karhunen-Loeve transform (KLT), or the like. Video encoder 107 produces transform coefficients following application of the one or more transforms.

As noted above, following any transforms to produce transform coefficients, video encoder 107 may perform quantization of the transform coefficients. Quantization generally refers to a process in which transform coefficients are quantized to possibly reduce the amount of data used to represent the transform coefficients, providing further compression. By performing the quantization process, video encoder 107 may reduce the bit depth associated with some or all of the transform coefficients. For example, video encoder 107 may round an n-bit value down to an m-bit value during quantization, where n is greater than m. In some examples, to perform quantization, video encoder 107 may perform a bitwise right-shift of the value to be quantized.

Following quantization, video encoder 107 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 107 may utilize a predefined scan order to scan the quantized transform coefficients to produce a serialized vector, and then entropy encode the quantized transform coefficients of the vector. In other examples, video encoder 107 may perform an adaptive scan. After scanning the quantized transform coefficients to form the one-dimensional vector, video encoder 107 may entropy encode the one-dimensional vector, e.g., according to context-adaptive binary arithmetic coding (CABAC). Video encoder 107 may also entropy encode values for syntax elements describing metadata associated with the encoded video data for use by video decoder 121 in decoding the video data.

To perform CABAC, video encoder 107 may assign a context within a context model to a symbol to be transmitted. The context may relate to, for example, whether neighboring values of the symbol are zero-valued or not. The probability determination may be based on a context assigned to the symbol.

Video encoder 107 may further generate syntax data, such as block-based syntax data, picture-based syntax data, and sequence-based syntax data, to video decoder 121, e.g., in a picture header, a block header, a slice header, or other syntax data, such as a sequence parameter set (SPS), picture parameter set (PPS), or video parameter set (VPS). Video decoder 121 may likewise decode such syntax data to determine how to decode corresponding video data.

In this manner, video encoder 107 may generate a bitstream including encoded video data, e.g., syntax elements describing partitioning of a picture into blocks (e.g., CUs) and prediction and/or residual information for the blocks. Ultimately, video decoder 121 may receive the bitstream and decode the encoded video data.

In general, video decoder 121 performs a reciprocal process to that performed by video encoder 107 to decode the encoded video data of the bitstream. For example, video decoder 121 may decode values for syntax elements of the bitstream using CABAC in a manner substantially similar to, albeit reciprocal to, the CABAC encoding process of video encoder 107. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 121 may inverse quantize and inverse transform the quantized transform coefficients of a block to reproduce a residual block for the block. Video decoder 121 uses a signaled prediction mode (intra-or inter-prediction) and related prediction information (e.g., motion information for inter-prediction) to form a prediction block for the block. Video decoder 121 may then combine the prediction block and the residual block (on a sample-by-sample basis) to reproduce the original block. Video decoder 121 may perform additional processing, such as performing a deblocking process to reduce visual artifacts along boundaries of the block.

However, in accordance with one or more examples described in this disclosure, in a first mode, also called normal mode, video decoder 121 may use a prediction block from a reference frame that is substantially the same or the same as the prediction block from the reference frame that video encoder 107 used. In a second mode, also called low power mode, video decoder 121 may use a prediction block from a lossy reference frame. The lossy reference frame may be generated based on decompression of a lossy compressed reference frame.

Operating video decoder 121 in different modes of operation may provide power savings, while minimizing negative impact on visual quality. For instance, video decoder 121 may utilize a large portion of memory 120. Video codecs such as for H.264, H.265, or H.266 may require sixteen reference frames to decode one frame. This can result in 50 mega-byte (MB), 200 MB, and 800 MB memory footprint for 1080p video, ultra-high definition (UHD) video, and 8 KUHD resolution in 8-bit, respectively. If the video is in 10-bit resolution, the memory footprint may double to 1600 MB for 8 KUHD.

In addition to requiring a relatively large memory footprint, the power consumption of writing to and reading from memory 120 may be relatively high. For instance, after video decoder 121 decodes (e.g., reconstructs) a current frame, video decoder 121 may write the current frame to memory 120 so that the current frame can be used as a reference frame for a subsequent frame. When needed to be used as a subsequent frame, video decoder 121 may read that frame (e.g., reference frame) from memory 120.

The power consumption of memory 120 may be based on the amount of data written to or read from memory 120, referred to as memory transactions. Accordingly, reduction in memory transactions with memory 120 may result in reduced overall power. For instance, reduced memory transactions means reduced bandwidth utilization of the bus that connects video decoder 121 and memory 120. Lower bandwidth utilization means a lower operation corner (e.g., lower voltage) used for memory 120, resulting in lower power consumption.

To reduce power consumption, in some examples, video decoder 121 or some other circuitry (e.g., compression circuitry) may be configured to compress a frame to generate a compressed frame, and write the compressed frame to memory 120. This way, the amount of data that is written to memory 120 is reduced. When the frame is needed as a reference frame, video decoder 121 or some other circuitry (e.g., decompression circuitry) may decompress the compressed frame to generate the reference frame. Because the compressed frame is read, instead of the original frame, the amount of data that is read from memory 120 is reduced.

In some examples, the compression circuitry and the decompression circuitry may be part of video decoder 121. In some examples, the compression circuitry and the decompression circuitry may be separate from video decoder 121, but part of the same integrated circuit (IC) chip (e.g., SoC chip) as video decoder 121. For ease, the compression and decompression circuitry are described as separate from video decoder 121, but on the same IC chip. However, the techniques are not so limited.

In some techniques, the compression applied to the frame is lossless compression. In this manner, when decompressed, the decompressed frame is substantially the same or the same as the frame prior to compression (e.g., since lossless compression is used). However, compared to lossless compression, lossy compression (e.g., with fixed 2:1 lossy or no fixed ratio) can achieve much higher compression ratio and guaranteed memory footprint with fixed ratio. A higher compression ratio for lossy compression means that the amount of data in a lossless compressed frame is greater than the amount of data in a lossy compressed frame, and therefore, the amount of data that is written or read for a lossy compressed frame is less than the amount of data that is written or read for a lossless compressed frame.

In accordance with one or more examples described in this disclosure, video decoder 121 and/or the compression circuitry may be configured to lossless compress frames in a first mode (e.g., normal mode) for writing to memory 120, such as when power savings are not overly beneficial. However, in a second mode (e.g., power saving mode), video decoder 121 and/or the compression circuitry may be configured to lossy compress frames in a second mode (e.g., low power mode) for writing to memory 120.

Accordingly, in a first mode, video decoder 121 may be configured to decode a first frame based on a first reference frame stored in memory 120. In a second mode, video decoder 121 may be configured to decode the second frame based on a second lossy reference frame. The second lossy reference frame may be generated based on decompression of a lossy compressed reference frame.

For example, in the first mode, compression circuitry may receive a decoded frame (e.g., decoded by video decoder 121), and perform lossless compression on the decoded frame to generate the lossless compressed reference frame. The compression circuitry may then write the lossless compressed reference frame in memory 120. The decompression circuitry may receive the lossless compressed reference frame, and decompress the lossless compressed reference frame to generate the first reference frame. Video decoder 121 may use the first reference frame to decode the first frame in the first mode.

In the second mode, compression circuitry may receive a decoded frame (e.g., decoded by video decoder 121), and perform lossy compression on the decoded frame to generate the lossy compressed reference frame. The compression circuitry may write the lossy compressed reference frame in memory 120 or memory local to the IC or video decoder 121, as described in more detail below. The decompression circuitry may receive the lossy compressed reference frame, and decompress the lossy compressed reference frame to generate the second lossy reference frame. Video decoder 121 may use the second lossy reference frame to decode the second frame in the second mode.

This disclosure may generally refer to “signaling” certain information, such as syntax elements. The term “signaling” may generally refer to the communication of values for syntax elements and/or other data used to decode encoded video data. That is, video encoder 107 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

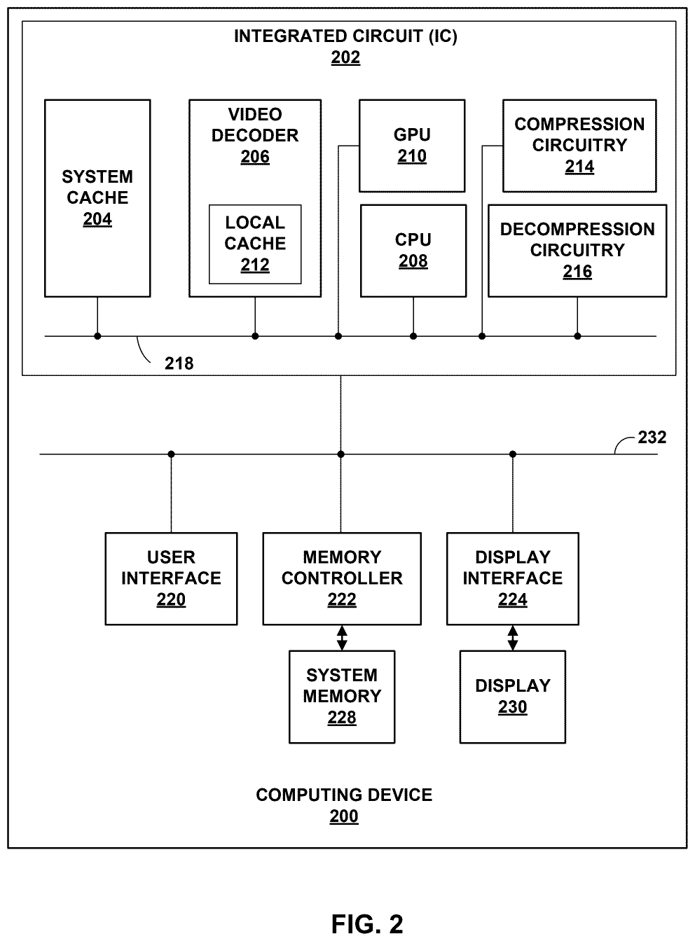

FIG. 2 is a block diagram illustrating an example a computing device that may perform the techniques of this disclosure. As illustrated in the example of FIG. 2, computing device 200 includes integrated circuit (IC) 202. IC 202 is an example of a system-on-chip (SoC). IC 202 includes system cache 204, video decoder 206, graphics processing unit (GPU) 210, central processing unit (CPU) 208, compression circuitry 214, decompression circuitry 216, and internal bus 218. Video decoder 206 is an example of video decoder 121 of FIG. 1.

Compression circuitry 214 and decompression circuitry 216 are illustrated separately, but may be combined into a compression/decompression circuitry. In this disclosure, description of compression circuitry 214 and decompression circuitry 216 may be considered as examples where compression circuitry 214 and decompression circuitry 216 are separate or combined circuitry. Moreover, compression circuitry 214 and decompression circuitry 216 are illustrated as separate from video decoder 206, but may be part of video decoder 206 in other examples.

As illustrated, video decoder 206 includes local cache 212, which may be considered as L1 cache in some examples. In one or more examples, local cache 212 may be dedicated memory for video decoder 206. That is, local cache 212 may not be available to other components such as GPU 210 or CPU 208 for storage. Local cache 212 need not necessarily be part of video decoder 206.

System cache 204 may be memory that is shared by the various components of IC 202. For instance, video decoder 206, GPU 210, CPU 208, compression circuitry 214, and decompression circuitry 216 may be configured to write to and read from system cache 204. System cache 204 may provide limited storage space (e.g., limited amount of memory), but may provide relatively fast access as components other than those of IC 202 (e.g., other components of device 200) may not compete for access to system cache 204.

Internal bus 218 may be a bus that interconnects the components of IC 202. For instance, video decoder 206, GPU 210, CPU 208, compression circuitry 214, and decompression circuitry 216 may write to and read from system cache 204 using internal bus 218.

Computer device 200 further includes user interface 220, memory controller 222 that provides access to system memory 228, and display interface 224 that outputs signals that cause graphical data to be displayed on display 230. In some examples, one or more of user interface 220, memory controller 222, and display interface 224 may be part of IC 202, but are shown external to IC 202 for ease. Also, system memory 228 is an example of memory 120 of FIG. 1, and may be a double data rate (DDR) based memory such as a DDR synchronous dynamic random-access memory (DDR SDRAM).

Also, although IC 202 is a SoC, in some examples, video decoder 206, GPU 210, and CPU 208 may be formed on separate (IC) chips. Various other permutations and combinations are possible, and the techniques should not be considered limited to the example illustrated in FIG. 2. The various components illustrated in FIG. 2 (whether formed on one device or different devices) may be formed as at least one of fixed-function or programmable circuitry such as in one or more microprocessors, application specific integrated circuits (ASICs), field programmable gate arrays (FPGAs), digital signal processors (DSPs), or other equivalent integrated or discrete logic circuitry.

The various units illustrated in FIG. 2 communicate with each other using bus 232. Bus 232 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced eXtensible Interface (AXI) bus) or another type of bus or device interconnect. It should be noted that the specific configuration of buses and communication interfaces between the different components shown in FIG. 2 is merely exemplary, and other configurations of computing devices and/or other image processing systems with the same or different components may be used to implement the techniques of this disclosure.

CPU 208 may comprise a general-purpose or a special-purpose processor that controls operation of computing device 200. A user may provide input to computing device 200 to cause CPU 208 to execute one or more software applications. The user may provide input to computing device 200 via one or more input devices (not shown) such as a keyboard, a mouse, a microphone, a touch pad or another input device that is coupled to computing device 200 via user interface 220.

One example of the software application is a video application. CPU 208 executes the video application, and in response, the video application causes video decoder 206 to generate content that display 230 outputs. For example, video decoder 206 may access encoded video content stored via a computer-readable medium 110, storage device 112, or file server 114.

GPU 210 may generate graphical information that is displayed along with the video content. For instance, GPU 210 may generate a graphic that allows for skip or rewind, and other such graphic icons that a user can interact with while playing video content.

Memory controller 222 facilitates the transfer of data going into and out of system memory 228. For example, memory controller 222 may receive memory read and write commands, and service such commands with respect to memory 228 in order to provide memory services for the components in computing device 200. Memory controller 222 is communicatively coupled to system memory 228. Although memory controller 222 is illustrated in the example of computing device 200 of FIG. 2 as being a processing circuit that is separate from both CPU 208 and system memory 228, in other examples, some or all of the functionality of memory controller 222 may be implemented on one or both of CPU 208 and system memory 228.

System memory 228 may store program modules and/or instructions and/or data that are accessible by video decoder 206, CPU 208, and GPU 210. For example, system memory 228 may store reference frames that video decoder 206 uses for decoding video content. System memory 228 is an example of memory 120 and may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media or an optical storage media.

In some examples, system memory 228 is a non-transitory storage medium. The term “non-transitory” indicates that the storage medium is not embodied in a carrier wave or a propagated signal. However, the term “non-transitory” should not be interpreted to mean that system memory 228 is non-movable or that its contents are static. As one example, system memory 228 may be removed from computing device 200, and moved to another device. As another example, memory, substantially similar to system memory 228, may be inserted into computing device 200. In certain examples, a non-transitory storage medium may store data that can, over time, change (e.g., in RAM).

Video decoder 206 may store frames, and the like in respective buffers that are allocated within system memory 228. Display interface 224 may retrieve the frames from system memory 228 and configure display 230 to display the frames. In some examples, display interface 224 may include a digital-to-analog converter (DAC) that is configured to convert the digital values retrieved from system memory 228 into an analog signal consumable by display 230. In other examples, display interface 224 may pass the digital values directly to display 230 for processing.

Display 230 may include a monitor, a television, a projection device, a liquid crystal display (LCD), a plasma display panel, a light emitting diode (LED) array, or another type of display unit. Display 118 may be integrated within computing device 200. For instance, display 230 may be a screen of a mobile telephone handset or a tablet computer. Alternatively, display 230 may be a stand-alone device coupled to computing device 200 via a wired or wireless communications link. For instance, display 230 may be a computer monitor or flat panel display connected to a personal computer via a cable or wireless link.

In one or more examples, video decoder 206 may be configured to decode a frame, and that frame may then be used as a reference frame to decode a subsequent frame. That is, samples in the reference frame may be used by video decoder 206 to generate a prediction block for a block in a subsequent frame. Video decoder 206 may receive residual values indicative of a difference between the prediction block and the block in the subsequent frame, and video decoder 206 may add the residual values to the prediction block to reconstruct the block of the subsequent frame.

Accordingly, after decoding a frame, video decoder 206 may be configured to write the frame to system memory 228 so that the frame can be used as a reference frame. In some examples, to reduce power consumption, video decoder 206 may output the frame to compression circuitry 214. Compression circuitry 214 may perform lossless compression to the frame, and store the resulting lossless compressed frame to system memory 228. Then, when video decoder 206 is to use the frame as a reference frame, decompression circuitry 216 may read (e.g., receive) the lossless compressed frame from system memory 228, decompress the lossless compressed frame to generate the reference frame, and output the reference frame to video decoder 206.

The example where compression circuitry 214 performs lossless compression or where no compression is applied may be considered as a first mode of operation, also called normal mode. That is, in the first mode, the decoding output is the expected output in accordance with video coding standard used to encode the frames.

In accordance with examples described in this disclosure, video decoder 206 and compression circuitry 214 may be configured to operate in a second mode, also called low power mode. In the second mode, to reduce the amount of data that is written to or read from system memory 228, compression circuitry 214 may be configured to perform lossy compression. Lossy compression tends to compress the data of a frame more than lossless compression, but results in data loss (i.e., the original frame may not be able to be reconstructed). Therefore, with lossy compression, the amount of data that is written to or read from system memory 228 is reduced, which results in less power consumption and bandwidth utilization of bus 232.

In the first mode, after video decoder 206 decodes (e.g., reconstructs) a frame, compression circuitry 214 performs lossless compression to generate a lossless compressed reference frame, and writes the lossless compressed reference frame to system memory 228. In the first mode, when video decoder 206 is to use the frame that was compressed and written to system memory 228 as a reference frame, decompression circuitry 216 reads (e.g., receives) the lossless compressed reference frame, performs decompression, and generates a reference frame. Video decoder 206 then uses the reference frame for decoding a subsequent frame. In the first mode, the compression and decompression may be skipped, such as if power savings are not needed.

In the second mode, after video decoder 206 decodes (e.g., reconstructs) a frame, compression circuitry 214 performs lossy compression to generate a lossy compressed reference frame, and writes the lossy compressed reference frame to system memory 228. In the second mode, when video decoder 206 is to use the frame that was compressed and written to system memory 228 as a reference frame, decompression circuitry 216 reads (e.g., receives) the lossy compressed reference frame, performs decompression, and generates a lossy reference frame. Video decoder 206 then uses the lossy reference frame for decoding a subsequent frame.

Accordingly, in a first mode, video decoder 206 may decode a first frame based on a first reference frame stored in system memory 228. In a second mode, video decoder 206 may decode a second frame based on a second lossy reference frame. The second lossy reference frame may have been generated (e.g., by decompression circuitry 216) based on decompression of a lossy compressed reference frame.

In some examples, lossy compression may be able to compress a frame such that the amount of data in the lossy compressed frame is small enough that the lossy compressed frame can be stored on IC 202. For instance, if the amount of data in a lossy compressed reference frame is small enough, compression circuitry 214 may write the lossy compressed reference frame to system cache 204 using bus 218 or local cache 212. In this example, decompression circuitry 216 may receive the lossy compressed reference frame from system cache 204 or local cache 212, perform decompression, and output the lossy reference frame to video decoder 206. In such examples, access to system memory 228 is not needed, which further reduces power consumption.

For example, in the second mode, compression circuitry 214 may receive a decoded frame (e.g., as decoded by video decoder 206), and perform lossy compression on the decoded frame to generate the lossy compressed reference frame. Compression circuitry 214 may write the lossy compressed reference frame in the memory (e.g., system memory 228) or memory local to the IC (e.g., system cache 204) or video decoder 206 (e.g., local cache 212). In such examples, decompression circuitry 216 may receive (e.g., read) the lossy compressed reference frame (e.g., from system memory 228, system cache 204, or local cache 212), and decompress the lossy compressed reference frame to generate the second lossy reference frame that is used to decode the second frame in the second mode.

However, in the first mode, compression circuitry 214 may be configured to receive a decoded frame (e.g., as decoded by video decoder 206), and perform lossless compression on the decoded frame to generate the lossless compressed reference frame. Compression circuitry 214 may write the lossless compressed reference frame in the memory (e.g., system memory 228). Decompression circuitry 216 may be configured to receive (e.g., read) the lossless compressed reference frame (e.g., from system memory 228), and decompress the lossless compressed reference frame to generate the first reference frame that is used to decode the first frame in the first mode.

There may be certain conditions on the lossless and lossy compression and decompression that compression circuitry 214 and decompression circuitry 216 perform. The following are some example conditions, but the techniques should not be considered as requiring these conditions.

One condition may be that the lossless and lossy compression is performed on a decoded frame. The lossless or lossy compression may occur as video decoder 206 is decoding the frame, or may occur after video decoder 206 completes decoding the frame. For instance, as video decoder 206 is decoding the frame, video decoder 206 may output to local cache 212 the portions of the frame that are decoded, and compression circuitry 214 may access local cache 212 as video decoder 206 is decoding the frame. As another example, video decoder 206 may complete decoding the frame, and stored the decoded frame in local cache 212 or system cache 204. Compression circuitry 214 may access the decoded frame from local cache 212 or system cache 204.

Another condition may be that the lossless and lossy compression and decompression is performed relatively quickly. The lossless and lossy compression and decompression may need to occur at runtime, and delays in compression and decompression may impact the playback rate and require needless buffering of video content. Accordingly, in some examples, for lossless and lossy compression or decompression, compression circuitry 214 and decompression circuitry 216 may utilize samples only from the frame being compressed or decompressed and not samples from any other frame. Also, techniques like entropy encoding or decoding, transforms, etc. may not be available, but may be available in some examples.

The following is an example technique for lossless and lossy compression and decompression. The techniques of this disclosure are not limited to any particular lossless or lossy compression technique, and the following is provided merely to assist with understanding.

For lossless and lossy compression, compression circuitry 214 may partition a frame into a plurality of blocks. As one example, the block may be a 2×2 block, but other sizes are possible. For ease of understanding, the example is described with respect to a 2×2 block, which includes a top-left sample, a top-right sample, a bottom-left sample, and bottom-right sample.

For lossless compression, compression circuitry 214 may pass through the sample values for the top-left sample of a block. For the top-right sample, compression circuitry 214 may output a difference between the sample values for the top-left sample and the top-right sample, instead of the sample values for the top-right sample. For the bottom-left sample, compression circuitry 214 may output a difference between the sample values for the top-left sample and the bottom-left sample, instead of the sample values for the bottom-left sample. For the bottom-right sample, compression circuitry 214 may output a difference between the sample values for the top-left sample and the bottom-right sample, instead of the sample values for the bottom-right sample. Decompression circuitry 216 may perform the inverse to reconstruct the block.

For lossy compression, compression circuitry 214 may right-shift by two (e.g., divide by two or remove the two least significant bits) the sample values for the top-left sample of a block, and output those values as the values for the top-left sample. For the top-right sample, compression circuitry 214 may determine a difference between the sample values for the top-left sample and the top-right sample and right-shift the resulting value by two (e.g., divide by two or remove the two least signification bits). Compression circuitry 214 may output the result of the right-shifting for the values of the top-right sample. For the bottom-left sample, compression circuitry 214 may determine a difference between the sample values for the top-left sample and the bottom-left sample and right-shift the resulting value by two (e.g., divide by two or remove the two least signification bits). Compression circuitry 214 may output the result of the right-shifting for the values of the bottom-left sample. For the bottom-right sample, compression circuitry 214 may determine a difference between the sample values for the top-left sample and the bottom-right sample and right-shift the resulting value by two (e.g., divide by two or remove the two least signification bits). Compression circuitry 214 may output the result of the right-shifting for the values of the bottom-right sample.

Decompression circuitry 216 may perform the inverse to reconstruct the block. For instance, decompression circuitry 216 may replace the two least significant bits with zero, and then perform the inverse operations to reconstruct block. Because there are lost bits in lossy compression, after decompression, the lossy reference frame may not be the same as the original reference frame.

There may be various factors that are used to determine whether the first mode or the second mode is selected as the mode of operation. Video decoder 206 or CPU 208 may select the mode, in some examples. For example, a resolution of frames to be decoded may control the whether the first mode or the second mode is used. For instance, if the frame is 1080p/UHD, then video decoder 206 or CPU 208 may select the second mode; otherwise, video decoder 206 or CPU 208 may select the first mode. A power level of device 200 may control whether the first mode or the second mode is used. For instance, if the battery of device 200 is relatively low, video decoder 206 or CPU 208 may select the second mode; otherwise, video decoder 206 or CPU 208 may select the first mode. A user selection may control whether the first mode or the second mode is used. For example, display 230 may output a user selection graphic with which the user interacts to select the first mode, if longevity of device 200 before recharge is not of concern, or to select the second mode, if longevity of device 200 before recharge is of concern.

As described above, because the lossy reference frame is different than the reference frame that video encoder 107 used to generate residual values, the reconstruct frame that used the lossy reference frame is different than (e.g., has lower visual quality) the actual frame. In many cases, the degradation in visual quality may be imperceivable to the user. However, there may be ways to reduce the degradation in visual quality, without significant increase in power.

As one example, video decoder 206 and compression circuitry 214 may operate in the first mode for a luma component of a frame (e.g., a first frame, where the first frame refers to a luma component of the frame), but operate in the second mode for the chroma component of the same frame (e.g., a second frame, where the second frame refers to a chroma component of the frame). In general, chroma components have less impact on visual quality than luma components. Therefore, a lossy chroma component for the reference frame may not impact visual quality, but provide reduction in power.

For instance, for in 4:2:0 color format, the chroma component is quarter size of the luma component, therefore there may be some amount of reduction in power by lossy compressing the chroma component. However, with 4:2:2 or 4:4:4 color formats where the chroma components are half or same size as the luma component, there may be substantial power savings by lossy compressing the chroma component without impact on visual quality.

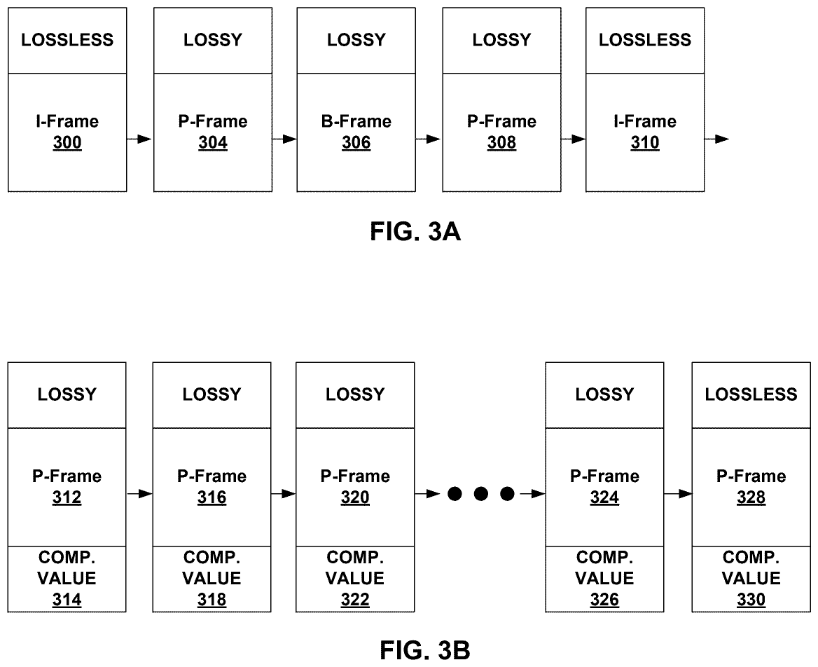

In some examples, video decoder 206 and compression circuitry 214 may switch between the first mode and the second mode back and forth. As one example, as described with respect to FIG. 3A, if a frame to be decoded is an intra refresh frame, compression circuitry 214 may perform lossless compression. For other frames, compression circuitry 214 may perform lossy compression.

As another example, as described in more detail with respect to FIG. 3B, compression circuitry 214 may determine some quality statistics such as a compression value indicative of an amount by which a frame is compressed. An example of the compression value is a compression ratio per frame (e.g., a ratio of the amount of data in the lossy compressed frame to the original frame). CPU 208, or some other component include compression circuitry 214, may determine whether a condition is satisfied based on the compression value. For instance, CPU 208 may determine whether the compression value for each lossy frame satisfies a threshold. Based on the determination the compression value for each lossy frame stratifies the threshold, compression circuitry 214 may perform lossless compression for another set of frames (e.g., for a predefined number of frames or time).

FIGS. 3A and 3B are flow diagrams illustrating examples of frames that are compressed using lossless or lossy compression. In FIG. 3A, because frame 300 is an intra refresh frame, compression circuitry 214 may operate in the first mode and perform lossless compression. Because frames 304, 306, and 308 are not intra refresh frames, compression circuitry 214 may operate in the second mode and perform lossy compression. In FIG. 3A, because frame 310 is an intra refresh frame, compression circuitry 214 may operate in the first mode and perform lossless compression.

In FIG. 3B, there are a first set of frames 312, 316, 320, and 324. Compression circuitry 214 may perform lossy compression on the first set of frames to generate a first set of lossy frames. Compression circuitry 214 may determine a compression value for each lossy frame of the first set of lossy frames, the compression value indicative of an amount by which each frame in the first set of lossy frames is compressed. In some examples, if CPU 208 or some other circuitry determines the compression value, that circuitry may be considered part of compression circuitry 214.

As one example, the compression value may be the compression ratio (e.g., ratio of amount of data in lossy compressed frame to the actual data prior to compression). For example, compression value 314 is the compression value for frame 312, compression value 318 is the compression value for frame 316, compression value 322 is the compression value for frame 320, and compression value 326 is the compression value for frame 324.

CPU 208 may be configured to determine that the compression value for each lossy frame of the first set of lossy frames satisfies a threshold. For example, CPU 208 may determine that compression values 314, 318, 322, and 326 are greater than a threshold for a certain number of frames (e.g., the number of frames or the amount of time it takes to display frames 312, 316, 310, and 324). As one example, assume that the compression value is the compression ratio. CPU 208 may determine that the compression ratio is greater than 2.5 for more than 5 seconds.

Based on the determination that the compression value for each lossy frame of the first set of lossy frame satisfies the threshold, compression circuitry 214 may perform lossless compression for a second set of frames following the first set of frames to generate a set of lossless frames (e.g., generate the set of lossless frames in the first mode). For instance, the second set of frames may include a certain number of frames (e.g., the number of frames that can be played back in 2 seconds). Video decoder 206 may then decode a third set of frames based on the set of lossless frames (e.g., in the first mode).

For instance, in the example of FIG. 3B, compression circuitry 214 may perform lossless compression on frame 328, and also determine the compression value 330 of frame 328. Then, video decoder 206 may utilize frame 328 as a reference frame, and the reference frame may be the same as frame 328 since lossless compression was utilized.

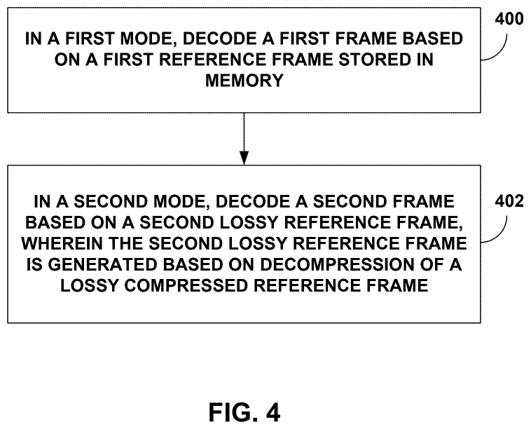

FIG. 4 is a flowchart illustrating an example method of processing video data. In a first mode (e.g., normal mode), video decoder 206 may decode a first frame based on a first reference frame stored in memory (e.g., system memory 228) (400). In some examples, the first reference frame may be an intra refresh frame or a luma component of a frame. That is the first reference frame may be a chroma lossy and luma lossless reference frame.

In a second mode (e.g., low power mode), video decoder 206 may decode a second frame based on a second lossy reference frame, where the second lossy reference frame is generated based on decompression of a lossy compressed referenced frame (402). The second lossy reference frame may be a chroma only lossy (luma lossless) frame or both chroma and luma lossy frame. That is, the second lossy reference frame may be a chroma lossy and luma lossless reference frame, where the chroma component is lossy compressed, but the luma component is not. As another example, the second lossy reference frame may be a reference frame where both the luma and chroma components are lossy compressed. In some examples, compression circuitry 214 may perform lossy compression to generate the lossy compressed reference frame that decompression circuitry 216 decompresses to generate the second lossy reference frame.

For instance, in a first mode, video decoder 206 may decode a first frame (e.g., luma component of a frame) based on a first reference frame (e.g., chroma lossy and luma lossless reference frame). In a second mode, video decoder 206 may decode a second frame (e.g., chroma component of the same frame) based on a second lossy reference frame (e.g., the same chroma lossy and luma lossless reference frame).

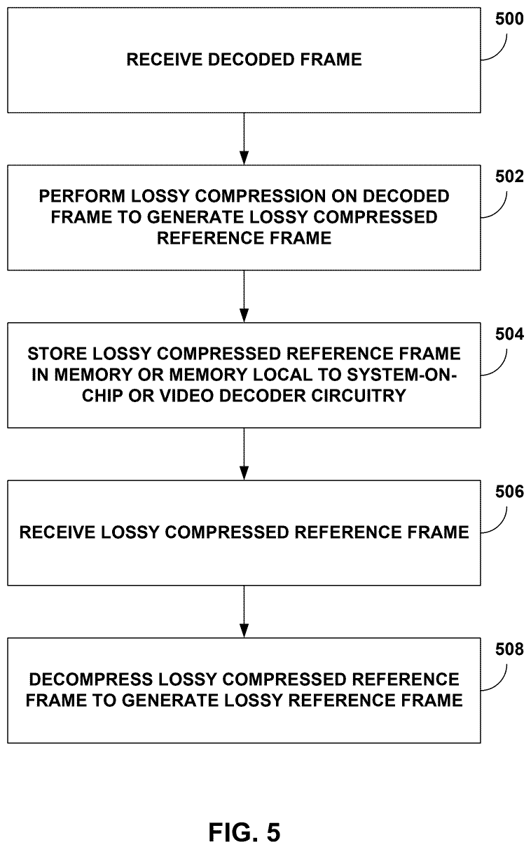

FIG. 5 is a flowchart illustrating another example method of processing video data. For instance, FIG. 5 illustrates an example of the second mode of operation (e.g., low power mode) for generating the second lossy reference frame used to decode the second frame of FIG. 4.

Compression circuitry 214 may receive a decoded frame (e.g., as decoded by video decoder 206) (500). Compression circuitry 214 may perform lossy compression on the decoded frame to generate a lossy compressed reference frame (502). Compression circuitry 214 may write the lossy compressed reference frame in the memory (e.g., system memory 228) or memory local to IC 202 (e.g., system cache 204) or video decoder 206 (e.g., local cache 212) (504).

Decompression circuitry 216 may receive (e.g., read) the lossy compressed reference frame (506). Decompression circuitry 216 may decompress the lossy compressed reference frame to generate the second lossy reference frame (508).

In some examples, video decoder 206 may then decode the second frame. For example, video decoder 206 may receive residual values indicative of a difference between samples of the second frame and samples of a reference frame. The lossy compressed frame is the reference frame after lossy compression. Video decoder 206 may reconstruct samples of the second frame based on adding the residual values to samples of the second lossy reference frame.

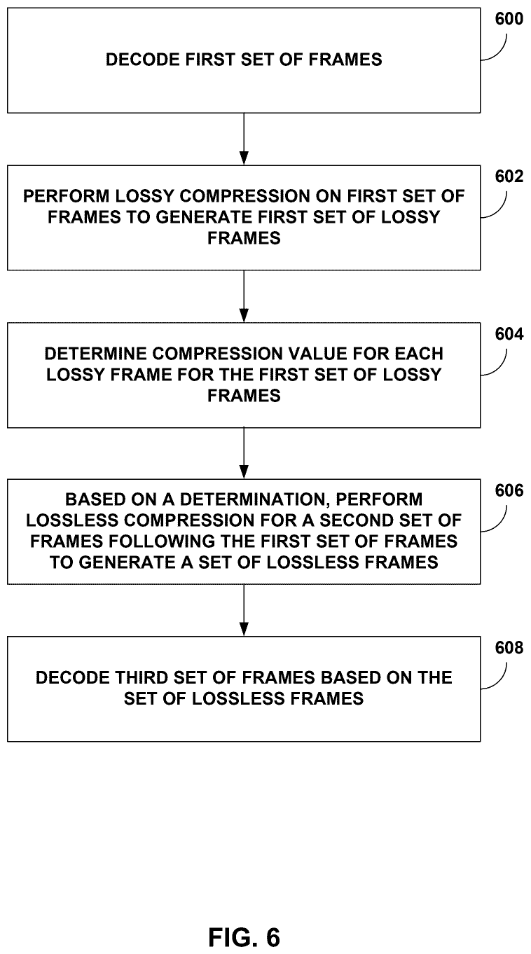

FIG. 6 is a flowchart illustrating another example method of processing video data. Video decoder 206 may be configured to decode a first set of frames (600). The first set of frames may be frames 312, 316, 320, and 324.

Compression circuitry 214 may perform lossy compression on the first set of frames to generate a first set of lossy frames (602). Compression circuitry 214 may determine a compression value for each lossy frame of the first set of lossy frames, the compression value indicative of an amount by which each frame in the first set of lossy frames is compressed (604). Examples of the compression values includes compression values 314, 318, 322, and 326.

Based on a determination that the compression value for each lossy frame of the first set of lossy frame satisfies the threshold, compression circuitry 214 may perform lossless compression for a second set of frames following the first set of frames to generate a set of lossless frames (606). For example, CPU 208 may execute firmware that determines whether the compression value for each lossy frame satisfies a threshold for a certain number of frames (e.g., compression ratio is greater than 2.5 for more than 5 seconds).

Video decoder 206 may be configured to decode a third set of frames based on the set of lossless frames (608). For instance, for a certain amount of time compression circuitry 214 may perform lossless compression, and video decoder 206 may decode frames based on the lossless frames. As an example, compression circuitry 214 may perform lossless compression on frames that follow frame 328, and for such frames, video decoder 206 may decode the frames using reference frames that were not lossy compressed.

The following example techniques may be used separately or in any combination.

Clause 1. A device for decoding video data, the device comprising: an integrated circuit (IC) comprising a video decoder; and a memory that is external to the IC and coupled to the IC, wherein the video decoder is configured to: in a first mode, decode a first frame based on a first reference frame stored in the memory; and in a second mode, decode a second frame based on a second lossy reference frame, wherein the second lossy reference frame is generated based on decompression of a lossy compressed reference frame.

Clause 2. The device of clause 1, wherein the IC comprises compression circuitry configured to: receive a decoded frame; perform lossy compression on the decoded frame to generate the lossy compressed reference frame; and write the lossy compressed reference frame in the memory or memory local to the IC or the video decoder, wherein the IC comprises decompression circuitry configured to: receive the lossy compressed reference frame; and decompress the lossy compressed reference frame to generate the second lossy reference frame.

Clause 3. The device of any of clauses 1 and 2, wherein the IC comprises compression circuitry configured to: receive a decoded frame; perform lossless compression on the decoded frame to generate a lossless compressed reference frame; and write the lossless compressed reference frame in the memory, wherein the IC comprises decompression circuitry configured to: receive the lossless compressed reference frame; and decompress the lossless compressed reference frame to generate the first reference frame.

Clause 4. The device of any of clauses 1-3, wherein the IC includes compression circuitry, wherein the video decoder is configured to decode a first set of frames following the second frame in coding order; wherein the compression circuitry is configured to: perform lossy compression on the first set of frames to generate a first set of lossy frames; determine a compression value for each lossy frame of the first set of lossy frames, the compression value indicative of an amount by which each frame in the first set of lossy frames is compressed; and based on a determination that the compression value for each lossy frame of the first set of lossy frame satisfies a threshold, perform lossless compression for a second set of frames following the first set of frames to generate a set of lossless frames, and wherein the video decoder is configured to decode a third set of frames based on the set of lossless frames.

Clause 5. The device of any of clauses 1-4, wherein the video decoder is configured to operate in the first mode or the second mode based on one or more of: a resolution of frames to be decoded; a power level of the device; or a user selection.

Clause 6. The device of any of clauses 1-5, wherein the first frame is a luma component of a frame, the second frame is a chroma component of the same frame, and the second lossy reference frame is a chroma lossy and luma lossless reference frame.

Clause 7. The device of clause 6, wherein the first reference frame is also the chroma lossy and luma lossless reference frame.

Clause 8. The device of any of clauses 1-7, wherein the first reference frame is an intra refresh frame.

Clause 9. The device of any of clauses 1-8, wherein to decode the second frame, the video decoder is configured to: receive residual values indicative of a difference between samples of the second frame and samples of a reference frame, wherein the lossy compressed frame is the reference frame after lossy compression; and reconstruct samples of the second frame based on adding the residual values to samples of the second lossy reference frame.

Clause 10. The device of any of clauses 1-9, wherein the device is a mobile phone, a laptop computer, or a tablet computer.

Clause 11. A method of decoding video data, the method comprising: in a first mode, decoding, with a video decoder in an integrated circuit (IC), a first frame based on a first reference frame stored in memory that is external to the IC and coupled to the IC; and in a second mode, decoding, with the video decoder, a second frame based on a second lossy reference frame, wherein the second lossy reference frame is generated based on decompression of a lossy compressed reference frame.

Clause 12. The method of clause 11, further comprising: receiving, with compression circuitry, a decoded frame; performing, with the compression circuitry, lossy compression on the decoded frame to generate the lossy compressed reference frame; writing, with the compression circuitry, the lossy compressed reference frame in the memory or memory local to the IC or the video decoder; receiving, with decompression circuitry, the lossy compressed reference frame; and decompressing, with the decompression circuitry, the lossy compressed reference frame to generate the second lossy reference frame.

Clause 13. The method of any of clauses 11 and 12, receiving, with compression circuitry, a decoded frame; performing, with the compression circuitry, lossless compression on the decoded frame to generate a lossless compressed reference frame; writing, with the compression circuitry, the lossless compressed reference frame in the memory; receiving, with decompression circuitry, the lossless compressed reference frame; and decompressing, with the decompression circuitry, the lossless compressed reference frame to generate the first reference frame.

Clause 14. The method of any of clauses 11-13, further comprising: decoding, with the video decoder, a first set of frames following the second frame in coding order; performing, with compression circuitry, lossy compression on the first set of frames to generate a first set of lossy frames; determining, with the compression circuitry, a compression value for each lossy frame of the first set of lossy frames, the compression value indicative of an amount by which each frame in the first set of lossy frames is compressed; based on a determination that the compression value for each lossy frame of the first set of lossy frame satisfies a threshold, performing, with the compression circuitry, lossless compression for a second set of frames following the first set of frames to generate a set of lossless frames; and decoding, with the video decoder, a third set of frames based on the set of lossless frames.

Clause 15. The method of any of clauses 11-14, further comprising operating in the first mode or the second mode based on one or more of: a resolution of frames to be decoded; a power level of a device; or a user selection.

Clause 16. The method of any of clauses 11-15, wherein the second lossy reference frame is a chroma lossy and luma lossless reference frame of a picture.

Clause 17. The method of clause 16, wherein the first reference frame is also the chroma lossy and luma lossless reference frame.

Clause 18. The method of any of clauses 11-17, wherein the first reference frame is an intra refresh frame.

Clause 19. The method of any of clauses 11-18, wherein decoding the second frame comprises: receiving residual values indicative of a difference between samples of the second frame and samples of a reference frame, wherein the lossy compressed frame is the reference frame after lossy compression; and reconstructing samples of the second frame based on adding the residual values to samples of the second lossy reference frame.

Clause 20. One or more computer-readable storage media storing instructions thereon that when executed cause a video decoder in an integrated circuit (IC) to: in a first mode, decode a first frame based on a first reference frame stored in memory that is external to the IC and coupled to the IC; and in a second mode, decode a second frame based on a second lossy reference frame, wherein the second lossy reference frame is generated based on decompression of a lossy compressed reference frame.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for decoding video data, the device comprising:
an integrated circuit (IC) comprising a video decoder; and
a memory that is external to the IC and coupled to the IC,
wherein the video decoder is configured to:
in a first mode, decode a first frame based on a first reference frame stored in the memory; and
in a second mode, decode a second frame based on a second lossy reference frame, wherein the second lossy reference frame is generated based on decompression of a lossy compressed reference frame.

2. The device of claim 1,
wherein the IC comprises compression circuitry configured to:
receive a decoded frame;
perform lossy compression on the decoded frame to generate the lossy compressed reference frame; and
write the lossy compressed reference frame in the memory or memory local to the IC or the video decoder,
wherein the IC comprises decompression circuitry configured to:
receive the lossy compressed reference frame; and
decompress the lossy compressed reference frame to generate the second lossy reference frame.

3. The device of claim 1,
wherein the IC comprises compression circuitry configured to:
receive a decoded frame;
perform lossless compression on the decoded frame to generate a lossless compressed reference frame; and
write the lossless compressed reference frame in the memory,
wherein the IC comprises decompression circuitry configured to:
receive the lossless compressed reference frame; and
decompress the lossless compressed reference frame to generate the first reference frame.

4. The device of claim 1,
wherein the IC includes compression circuitry,
wherein the video decoder is configured to decode a first set of frames following the second frame in coding order;
wherein the compression circuitry is configured to:
perform lossy compression on the first set of frames to generate a first set of lossy frames;
determine a compression value for each lossy frame of the first set of lossy frames, the compression value indicative of an amount by which each frame in the first set of lossy frames is compressed; and
based on a determination that the compression value for each lossy frame of the first set of lossy frame satisfies a threshold, perform lossless compression for a second set of frames following the first set of frames to generate a set of lossless frames, and
wherein the video decoder is configured to decode a third set of frames based on the set of lossless frames.

5. The device of claim 1, wherein the video decoder is configured to operate in the first mode or the second mode based on one or more of:
a resolution of frames to be decoded;
a power level of the device; or
a user selection.

6. The device of claim 1, wherein the first frame is a luma component of a frame, the second frame is a chroma component of the same frame, and the second lossy reference frame is a chroma lossy and luma lossless reference frame.

7. The device of claim 6, wherein the first reference frame is also the chroma lossy and luma lossless reference frame.

8. The device of claim 1, wherein the first reference frame is an intra refresh frame.

9. The device of claim 1, wherein to decode the second frame, the video decoder is configured to:
receive residual values indicative of a difference between samples of the second frame and samples of a reference frame, wherein the lossy compressed frame is the reference frame after lossy compression; and
reconstruct samples of the second frame based on adding the residual values to samples of the second lossy reference frame.

10. The device of claim 1, wherein the device is a mobile phone, a laptop computer, or a tablet computer.

11. A method of decoding video data, the method comprising:
in a first mode, decoding, with a video decoder in an integrated circuit (IC), a first frame based on a first reference frame stored in memory that is external to the IC and coupled to the IC; and
in a second mode, decoding, with the video decoder, a second frame based on a second lossy reference frame, wherein the second lossy reference frame is generated based on decompression of a lossy compressed reference frame.

12. The method of claim 11, further comprising:
receiving, with compression circuitry, a decoded frame;
performing, with the compression circuitry, lossy compression on the decoded frame to generate the lossy compressed reference frame;
writing, with the compression circuitry, the lossy compressed reference frame in memory;
receiving, with decompression circuitry, the lossy compressed reference frame; and
decompressing, with the decompression circuitry, the lossy compressed reference frame to generate the second lossy reference frame.

13. The method of claim 11,
receiving, with compression circuitry, a decoded frame;
performing, with the compression circuitry, lossless compression on the decoded frame to generate a lossless compressed reference frame;
writing, with the compression circuitry, the lossless compressed reference frame in memory;
receiving, with decompression circuitry, the lossless compressed reference frame; and
decompressing, with the decompression circuitry, the lossless compressed reference frame to generate the first reference frame.

14. The method of claim 11, further comprising:
decoding, with the video decoder, a first set of frames following the second frame in coding order;
performing, with compression circuitry, lossy compression on the first set of frames to generate a first set of lossy frames;
determining, with the compression circuitry, a compression value for each lossy frame of the first set of lossy frames, the compression value indicative of an amount by which each frame in the first set of lossy frames is compressed;
based on a determination that the compression value for each lossy frame of the first set of lossy frame satisfies a threshold, performing, with the compression circuitry, lossless compression for a second set of frames following the first set of frames to generate a set of lossless frames; and
decoding, with the video decoder, a third set of frames based on the set of lossless frames.

15. The method of claim 11, further comprising operating in the first mode or the second mode based on one or more of:
a resolution of frames to be decoded;
a power level of a device; or
a user selection.

16. The method of claim 11, wherein the second lossy reference frame is a chroma lossy and luma lossless reference frame of a picture.

17. The method of claim 16, wherein the first reference frame is also the chroma lossy and luma lossless reference frame.

18. The method of claim 11, wherein the first reference frame is an intra refresh frame.

19. The method of claim 11, wherein decoding the second frame comprises:
receiving residual values indicative of a difference between samples of the second frame and samples of a reference frame, wherein the lossy compressed frame is the reference frame after lossy compression; and
reconstructing samples of the second frame based on adding the residual values to samples of the second lossy reference frame.

20. One or more computer-readable storage media storing instructions thereon that when executed cause a video decoder in an integrated circuit (IC) to:
in a first mode, decode a first frame based on a first reference frame stored in memory that is external to the IC and coupled to the IC; and
in a second mode, decode a second frame based on a second lossy reference frame, wherein the second lossy reference frame is generated based on decompression of a lossy compressed reference frame.
